(19) United States
(12) Patent Application Publication
(10) Pub. No.: US 2017/0281314 A1
(43) Pub. Date: Oct. 5, 2017

(54) METHOD FOR PRDUCING A POSITIONING TRAY AND THE DEVICE THEREFOR

(71) Applicant: ANDREAS FREIMULLER, BERLIN-FROHNAU (DE)

(72) Inventor: ANDREAS FREIMULLER, BERLIN-FROHNAU (DE)

(21) Appl. No.: 15/508,340

(22) PCT Filed: Aug. 28, 2015
(86) PCT No.: PCT/EP2015/069747

§ 371 Date: Mar. 2, 2017

(30) Foreign Application Priority Data
Sep. 2, 2014 (DE) 102014217480.5

(51) Int. Cl. A61C 7/00; A61C 7/14

(52) U.S. Cl. CPC A61C 7/002; A61C 7/145; A61C 7/146

(57) ABSTRACT

The present invention relates to a method for producing a positioning tray for brackets of dental braces, wherein the positioning tray has a positioning aid and one or more associated brackets, wherein the positioning aid is formed as one piece with the associated bracket(s), comprising the following steps: obtaining original data which describe the present geometry of one or more teeth of at least one jaw of a patient; obtaining target data which describe the geometry of the one or more teeth of the at least one jaw of the patient after treatment with dental braces; calculating tray configuration data which describe the geometry of brackets with respect to the present geometry of the one or more teeth of the at least one jaw of the patient and the positioning aid arising from the original data and the target data, wherein the calculation of the tray configuration data is carried out such that using the described brackets of this type, the positioning aid is connected such that it can be used in order to position the brackets with respect to the teeth of the patient such that the bracket(s) can be connected to the surface of the teeth of the patient, and that, together with an ideal curve (basis for planning), previously determined and to be connected to (one of) the bracket(s), a correction of a malocclusion can be carried out; producing, on the basis of the tray configuration data, a corresponding positioning tray through a generative or ablative manufacturing method. The invention further relates to a corresponding device, a computer-readable storage medium and a corresponding positioning tray.

### TECHNICAL FIELD

The present invention relates to a method for producing a positioning tray comprising customized brackets in direct physical contact with a positioning aid, an apparatus which is suitable for such a method, and correspondingly produced positioning trays referred to as such in the following.

### PRIOR ART

Dental braces are a means for correcting a malocclusion. For this purpose, what are referred to as “brackets” can be bonded firmly to the corresponding teeth of a jaw of the patient. In the past, the standardized brackets manufactured industrially were typically composed of metal, ceramic or plastic. The brackets, on the side directed away from the tooth (bracket body), have a typically slot-like shape. This slot is used for inserting a round or square “arch wire” into the brackets. An arch wire is a thin piece of metal produced in a standardized or customized dental arch shape which due to its shape/arch wire size, when it is inserted in the bracket slot, exerts a force on this bracket in a certain defined direction according to the position of the bracket slot and the material characteristics of the arch wire. This force is transmitted to the teeth and ideally moves them in the direction planned by the dentist as a result of which a correction of the malocclusion takes place. Typically, a single arch wire is not sufficient for complete treatment of a malocclusion such that several arch wires in different cross-sections and made of various metal alloys have to be inserted. This normally results in a specific treatment duration of several years (approx. 1-3 years) during which the brackets remain on the teeth. They are only removed after the end of the treatment, i.e. if the malocclusion has been sufficiently corrected.

From the above, it can be seen that the positioning and also the choice of the type of brackets or bracket system and the choice of arch wire shape/size has to be adjusted to the patient, in particular to his tooth shape or size and also to the size of his individual dental arch. This means that it is necessary, by means of an analysis of the source findings/dental arch shape or size/degree of malocclusion/and planning of the specific treatment goal, to individually select the most “ideal” brackets and arch wires for the particular patient from the currently existing range of industrially manufactured and patented bracket systems and arch wire types.

Subsequently, accurate positioning of the brackets in respect of each individual tooth is then extremely important for the success of the treatment. Thus the bracket base typically has an area of only a few square millimeters, and the bracket slot for receiving the arch wire usually also has a width of less than 1 mm. This means that if the brackets are positioned even slightly incorrectly, it is no longer possible to implement correction of the malocclusion exactly as planned. The result would be that the corresponding bracket would have to be removed and repositioned either immediately or at a later date or the arch wire would have to be customized with additional bends in up to 3 planes which would lead to inconvenience for the patient, but not least to an extension of the treatment time.

In order to provide accordingly for easy positioning of the brackets, as is described for example in EP 2 614 791 A1, so-called positioning trays are used.

This document describes a “bracket” with a positioning aid and a transfer mask as well as a method for their production. The “bracket” is initially modeled with the help of a digital model of the jaw of the patient. Subsequently, a wax mold of the “bracket” is created with the help of a 3D printing process. Using the wax mold, the “bracket” is then created from a titanium alloy. The “bracket” thus manufactured is then adjusted on an original tooth impression, the transfer mask is created and the positioning aid is removed.

This positioning tray/track, after being filled with the appropriate composite, is then placed onto a corresponding tooth or the whole dental arch of a patient's jaw. The positioning tray molded over the brackets means that the bracket can automatically be positioned in the “right” position with respect to the tooth so that it can then be attached to the tooth, for example, with adhesive. After attachment, the positioning tray/track can then be removed and thus only the bracket remains on the tooth or the brackets remain on the teeth of a whole jaw.

### PRESENTATION OF THE INVENTION

The inventor has noticed that, according to the prior art, all previous methods are very time- and cost-intensive due to separation of the methods for producing or positioning customized or standardized brackets and the methods for producing corresponding positioning or transfer trays.

Until now, there has been no method for producing what is referred to in the following as a “transfer tray” in which the brackets are described in a direct single-step “workflow”—in physical connection with the necessary and what is referred to in the following as the “transfer aid” in a single-step production process.

Based on EP 2 614 791 A1, a hollow mold/transfer track always has to be manufactured in which the actual bracket(s) can be produced or simultaneously transferred by means of liquid light-curing composite, or with the help of which a previously custom-made or already industrially produced bracket can be positioned on the tooth/teeth. However, experience with the indirect bonding of brackets by using positioning tracks/trays previously produced in the thermo-forming technique has revealed disadvantages/risks among dentists and orthodontists using them. During removal of the tracks, which is often somewhat problematic or risky—due to possible increased retention of the brackets in the track as a consequence of the undercuts present between bracket body and bracket base—individual brackets can more frequently become detached immediately after the bonding of said brackets.

Excess adhesive residues are also frequently left at the margins of the bracket bases. This makes it necessary to carry out time-consuming finishing work, which is uncomfortable for the patient, using rotary carbide finishing burs in the area surrounding the brackets.

US 2014/0141383 A1, US 2013/0122445 A1, EP 2 724 685 A and KR 2014/063510 A describe further dental braces or production methods therefor from prior art.

The invention was carried out in view of these problems with the prior art. The invention solves these problems by means of the method for producing a positioning tray according to claim 1, by means of the apparatus according to claim 5, by means of the machine-readable storage medium according to claim 9 and by means of the positioning tray according to claim 10. Preferred embodiments are described in the dependent claims.

Claim 1 defines a method for producing a positioning tray for customized brackets including positioning aid/s directly physically connected thereto for a whole dental arch, a dental arch segment or individual teeth. These positioning trays comprise a positioning aid and one or more associated brackets. That is to say, such a positioning tray may be both a positioning tray that only has one bracket for a single tooth and also a positioning tray for several teeth which has several brackets that can each be attached to different teeth. In this case, the positioning tray may be suitable for attaching brackets to both the side of the teeth directed away from the tongue and also to the side of the teeth directed towards the tongue. The latter in particular is advantageous for many patients since the visual appearance of the teeth is not compromised as a result.

The positioning aid is typically an element modeled virtually over the incisal edges or the occlusal surfaces of the teeth. The bracket(s) is/are typically joined to the positioning aid and formed in one piece with it. The brackets are formed such that, on the side on which they are to be attached to the tooth, they are exposed so that they can be attached to the tooth, by means of an adhesive for example.

According to the present invention, the positioning aid is preferably formed in one piece with the associated bracket(s). That is to say, they are not separate objects but rather parts of a single connected positioning tray. However, in the present application, “in one piece” also means that the two parts can have different compositions as long as they are only manufactured as one piece.

The method comprises as a first step that the source data of the geometry of one or more teeth of one or both jaws of a patient are captured—also including the surrounding soft tissue and optionally also the hard tissue of a dental arch. Such capturing may take place, for example, with an intraoral 3D scan of the teeth/jaws. It would also be possible, however, to first take an impression of the teeth of a patient which is then correspondingly converted into 3D data. It may also involve importing data that has already been saved, that is to say the data need not first be generated separately. Apparatuses with which such intraoral data can he captured are already sufficiently available in the specialist dental trade.

By the word “geometry” we mean here the shape, position and orientation of the teeth including the adjacent soft tissue or, in the case of existing 3D data from X-rays, the bone surrounding the tooth. In other words, the word “geometry” denotes the shape described by the outer shape of the teeth and the tissue surrounding the tooth of the patient.

1st Virtual Planning Step:

As the next or “1st virtual planning step”, the target data must be planned/defined using correspondingly necessary software. The target data are data which describe the geometry to be achieved after treatment with dental braces for the jaw of a patient which is to be treated, Such target data can already be generated now with the help of suitable software (for example OnyxCeph™ by image Instruments GmbH or other suppliers). While the source data show the “actual state”, the target data describe the geometry of the dental arches which is to be achieved, i.e. the “target state”.

2nd Virtual Planning Step:

Based on this, initially only the bracket position is planned for the tray configuration to be planned virtually, only some of the tray configuration data being obtained at first. In this case, these are initially the data that describe which ideal position the bracket bodies must occupy in respect of the lingual or vestibular tooth surface in order to accommodate an “ideal arch wire” which matches the dental arch and is positioned according to certain criteria, and which has necessarily been selected already from a “virtual arch wire library” added to the software (for this, all existing lingual and vestibular arch wire shapes and dimensions of all manufacturers can be captured exactly 1:1 and can be made available in the software). Using this software, it will be possible to select the “appropriate” arch wire for the target dental arch configuration created in this 2nd virtual planning step. This is used so that, on the one hand, the bracket bodies or bracket bases can be designed as dose to the tooth surface as possible or as flat as possible to ensure maximum wearing comfort for the patient, On the other hand, when creating the software, a minimum distance of the arch wire from the tooth surface must also be defined to ensure the functional capability of the bracket in all its component parts. This is necessary to carry out a treatment with dental braces which moves the teeth from the starting geometry towards the ideal arch wire geometry to be achieved.

3rd Virtual Planning Step:

This means that, according to the position of the target arch wire chosen and positioned virtually, in the 3rd planning step software is then used to determine the mesial/distal position of the individual brackets according to the individual tooth widths and the size/shape of the bracket bodies and bases.

At the same time, master data of certain basic shapes of bracket bodies and bracket bases must be added to the software. The standard slot depth in the bracket body to be defined in the software and the standard height of the bracket bases to be adjusted can be optimized subsequently using appropriate software, according to the situation between arch wire and tooth surface.

4th Virtual Planning Step:

After this 3rd virtual planning step, positioning of the positioning aid in respect of the brackets is then described for each tooth in a 4th planning step. For this, the software must now reset the target setup created in the first virtual planning step to the starting or actual state. In the process, the virtually positioned brackets are placed in the starting position simultaneously with the teeth.

Subsequently, a positioning aid divided incisally or occlusally into one or more portions is planned virtually, said positioning aid is then joined virtually by means of standardized connecting elements directly to the bracket(s) or to the connecting elements between the brackets and ensures that the positioning aid can appropriately and safely position the brackets in the starting position in respect of the teeth. That is to say, the positioning aid ensures that the brackets are positioned in the right position in respect of the teeth in the starting position. If, in line with the manufactured and positioned brackets, the side which is in contact with the teeth is now provided with an adhesive and this adhesive cures, the brackets are automatically attached in the right position with respect to the teeth. The positioning aid can be removed again easily by separating it from the brackets which leaves the brackets stuck onto the tooth on the tooth. They can then, as described with reference to the prior art, be used with an arch wire of the ideal arch wire size, previously selected as the planning basis, for carrying out treatment with dental braces.

Due to the sequence of different arch wire thicknesses or arch wire cross-sections and arch wire material characteristics in the appropriately chosen ideal arch wire size of a selected manufacturer (from the arch wire library located in the software), it is thus possible step-by-step to implement shaping of the dental arch into the defined target position 1:1.

Based on the correspondingly generated data, after the 4th virtual planning step is complete, appropriate positioning trays are produced by means of an additive or ablative manufacturing process. That is to say, these brackets are immediately manufactured positively in a one piece combination with the positioning aid (=positioning tray). Thus, no negative mold is produced into which a corresponding liquid bracket material would have to be cast or which is only suitable for the physical accommodation/positioning of brackets.

Here a generative manufacturing process is a process in which the material that the brackets should be made of is applied directly, thus no negative mold is produced but rather a positive mold is created immediately. One example of such a process is a 3D printing process. Other processes, however, are also stereolithography, selective laser melting, selective laser sintering, fused deposition modeling, laminated object modeling and cold gas dynamic spraying. Another term which is used as the generic term for these processes is “rapid prototyping”.

In a generative manufacturing process, the materials that have already proven themselves for producing attachments/composite brackets can also be used as the materials for producing positioning trays. As examples, mention may be made of Transbond™ XT light-curing composite from 3M Unitek or Empress EnamelPlus HRI by Ivoclar/Vivadent. Furthermore, of course, all the materials which are used in dentistry for producing large area composite fillings and which can be cured, using UV light for example, can also be used.

An ablative manufacturing process is understood as all manufacturing processes in which the object to be manufactured can be produced from a blank. Thus a corresponding process could be, for example, computer-controlled milling (CNC milling) but any other ablative processes can also be used. In an ablative manufacturing process, the positioning tray could be produced from a ceramic blank, for example. Ceramic is characterized by good biological properties combined with high hardness which is advantageous for use in the oral cavity.

One advantage of the single-step production of brackets and positioning aid as a one-piece positioning tray in the positive process using generative or ablative manufacturing techniques is based on the fact that brackets and positioning aid are produced as a positioning tray in a single step without other intermediate steps which significantly shortens the time and effort needed for producing such positioning trays and the intraoral implementation. At the same time, sources of errors, risks when detaching the transfer trays produced in the negative process, such as during indirect bonding, and time-consuming refinishing in the oral cavity are reduced. The advantage of the fact that the brackets are joined to the positioning aids in one piece is that the structure of such a positioning tray is simpler. In other words, there is no need for—comparatively time-consuming—machining and joining of different materials to each other and rather it is sufficient if one material is used. This is more comfortable for the patient. It is quite conceivable for the oral cavity of a patient to be scanned in the morning and for it to be possible to attach an appropriate dental brace as a positioning tray the same afternoon.

Moreover, an orthodontist who realizes that such a positioning tray has been defectively produced can use the rapid prototyping process to produce a replacement tray relatively easily “in office” after rescanning. Furthermore, an orthodontist now has the option, without having to use industrially manufactured standard brackets or having to customize them using time-consuming methods or having to join them with elaborate transfer systems for more accurate placement, to select individual brackets from his own virtual bracket library “in office” and to customize the bracket base according to the tooth surface. He can shape them as desired and then produce them on site in his own practice. This increases the accuracy when implementing individually planned treatment goals, it increases the flexibility and also the effectiveness when treating a patient. Of course, it would also be possible, by using cloud applications for example, to use both software and also hardware from external suppliers in this process.

Details:

In a preferred embodiment, a point with reduced breaking strength can be formed in the positioning tray at the transition between the bracket/s and the associated positioning aid. Such a point can be produced, for example, in that the material has a reduced material thickness at this point or that the material is more brittle.

In this way, separation of the brackets from the positioning tray is facilitated, which makes it easier to remove them from a patient. This is because no special took are required to detach them from the remainder of the positioning tray and in particular the positioning aid.

It is further preferable to use a composite which is crosslinked with an increased proportion of ceramic particles in a generative manufacturing process. In this way, a bracket with high strength can be achieved.

Such materials are known as nano-hybrid filling materials.

it is further preferable in an ablative process for the positioning tray to be produced from a ceramic or composite blank. Ceramic blanks especially are characterized by high hardness which means that they are well suited for use in an oral cavity and can transmit forces to the teeth with only small losses. This blank can be produced by means of a milling process or specifically by means of a CNC milling process, similar to the Cerec-inlay, and veneer or crown production.

Moreover, an apparatus for producing a positioning tray according to claim S is an object of the invention. The description of the features and advantages corresponds substantially to the description that was provided above in respect of claim 1.

The source data in this case can be obtained by means of any device which is able to measure the oral cavity of a patient. Examples of this are the iTero Scanner among others.

The device for obtaining target data and for calculating the tray configuration data can be any device/software which is suitable for an appropriate calculation. In particular, it may be a computer on which appropriate software (e.g. OnyxCeph) is installed. With regard to dependent claims 6 to 8, reference is made to the advantages which are mentioned above with respect to the manufacturing process.

Furthermore, the present invention consists of the machine-readable storage medium according to claim 9. This is characterized in that it contains a computer program which is equipped to control a method according to one of claims 1 to 4.

Based on the source data and the target data, such a computer program can generate commands which can be executed by an apparatus that is designed for a generative process or an ablative process. Thus the computer program might generate control commands for a 3D printer or a CNC milling device (or generally for any device which is designed for a generative or ablative manufacturing process). Such a storage medium results in the advantages which were mentioned above with respect to the manufacturing process.

For example, a machine-readable storage medium may be a hard drive or a CD or also any other storage device. Such a storage medium also does not need to be present on site. For example, it can be an Internet server from which an appropriate computer program can be downloaded.

In addition, the invention is achieved by the positioning tray according to claim 10. This has a positioning aid and one or more associated bracket(s) which are designed to be physically connected to the positioning aid. The positioning tray can be made, for example, from a single ceramic or composite blank and can preferably have been manufactured by a generative or ablative process.

Such a positioning tray, in one piece consisting of brackets and positioning aid, has the advantages described with respect to the method and, if it is made from a single material, it is easier to manufacture than a positioning tray which is produced from or consists of different, successively occurring processes and materials in the workflow.

A preferred embodiment of the positioning tray is described in claim 11. This positioning tray can also have a predetermined breaking point as was described above with respect to claim 2 and results in corresponding advantages.

The positioning tray according to claim 10 or 11 can be produced by a method according to claim 1 to 4 or by an apparatus according to claims 5 to 8.

### BRIEF DESCRIPTION OF THE DRAWINGS

FIG. 1 shows schematically a positioning tray according to the invention.

FIG. 2 shows schematically a method according to the invention.

FIG. 3 shows a view of a modeled corrected dental arch with brackets attached to it and an ideal arch wire.

FIG. 4 is a plan view onto the teeth illustrated in FIG. 3 with attached brackets and ideal arch wire.

FIG. 5 is a front view of a computer model of uncorrected teeth with positioning trays mounted on them and associated brackets.

FIG. 5a is a plan view onto the arrangement according to FIG. 5.

FIG. 6 is a sectional view of a tooth which is illustrated in FIG. 5.

### DETAILED DESCRIPTION OF THE DRAWINGS

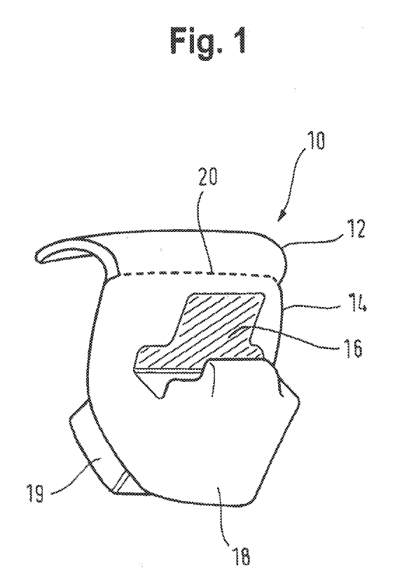

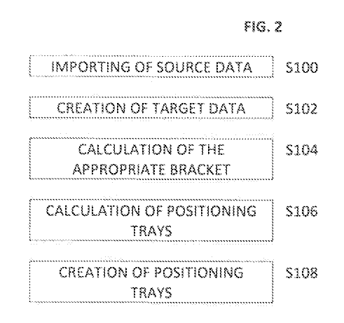

An embodiment of the invention is described in the following with reference to FIGS. 1 and 2. FIG. 2 shows a positioning tray 10 which can only be produced according to the method illustrated in FIG. 1 for positioning the brackets on the ideal target model. This positioning tray 10 comprises a positioning aid 12 which is joined to a bracket 14. This bracket 14 can be attached to a tooth, not shown, of a patient by providing it with an adhesive on the rear (not shown) which is cured as soon as the bracket is in contact with the tooth of the patient. The bracket 14 has a slot 16 into which an arch wire can be inserted. As soon as this arch wire has been inserted, it can be attached to the bracket 14 by means of a rubber band or by another means. An appropriate rubber band (not shown) is pulled over the protrusion which is created by the different width of bracket base 18 and bracket foot 19 such that it holds the arch wire in the groove 16.

In addition, a predetermined breaking point 20 can be formed between the positioning aid 12 and the bracket 14. This is formed by a selective weakening of the material at this point such that the positioning aid 12 can easily be snapped off the bracket 14 once this bracket 14 has been attached to the tooth of a patient.

FIG. 2 shows schematically a method for producing such a bracket. For this, source data are first imported in step S100. This importing can take place, for example, by means of a device which scans the oral cavity of a patient (intraoral scanner).

Based on this, target data are created (step S102) which illustrate how the teeth or the jaw of the patient should look after the treatment. That is to say, while the source data represent the actual state, the target data represent the target state.

In step S104, an appropriate ideal arch wire, which most closely corresponds to the curve of the target state of the dental arch created by the orthodontist using the software and further specific criteria (minimum distance to tooth surfaces, etc.), is then selected from the virtual arch wire library. Only after this are appropriate brackets determined or calculated. Calculation of “appropriate brackets” is understood as identifying the bracket positions which are able to passively accommodate the ideal arch wire already selected in their bracket slots. Thus later, after several successive changes of arch wire, the teeth of the patient can be translated from the actual configuration to the target configuration. In other words, when calculating the appropriate brackets this is part of the planning which the orthodontist only carries out after determining the ideal arch wire where, with the help of the software, he determines the exact position of the brackets in relation to the selected ideal arch wire (orientation of the bracket slot) and the teeth (height and inclination of the bracket foot).

As soon as these brackets have been appropriately determined or calculated, after using the software to reset the teeth, including the brackets now correspondingly positioned on the teeth, appropriate positioning trays are calculated. That is to say, a positioning aid is determined which is joined to the brackets and which is designed such that it can guarantee secure retention of the positioning tray on the dental arch by modeling it virtually over occlusal surfaces or incisal edges of individual teeth. Based on these calculated positioning trays, that is to say based on the calculated three-dimensional configuration data, appropriate positioning trays are produced, for example by means of a 3D printer,

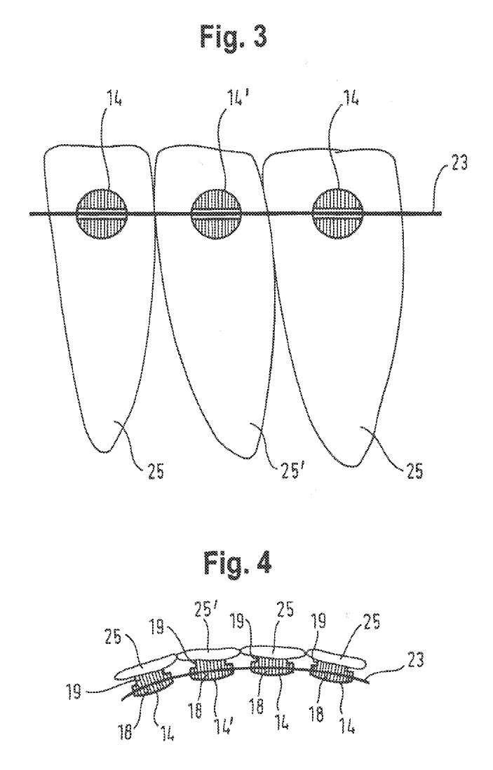

The method schematically and briefly illustrated in FIG. 2 will now be described again in detail with reference to FIGS. 3 to 6.

FIG. 3 shows a modeled arrangement of the brackets 14, 14′ on the lingual side of the teeth 25, 25′. These brackets 14, 14′ are attached on the inside of the teeth 25 (i.e. on the side which is directed towards the tongue) and are connected by an ideal arch wire 23. This arrangement is the configuration of the teeth 25, 25′ and the brackets 14,14′ to be achieved after correction of the malocclusion and is obtained after the third virtual planning step, as is described in the present application.

FIG. 4 shows a corresponding plan view onto this configuration from which further details can be seen. The teeth 25, 25′ which are connected by the virtual ideal arch wire 23 are also shown here. This plan view, which can also be described as a view along the incisal direction towards the teeth 25, 25′, shows the brackets 14, 14′ which are joined to the teeth 25, 25′ via a bracket base or bracket foot.

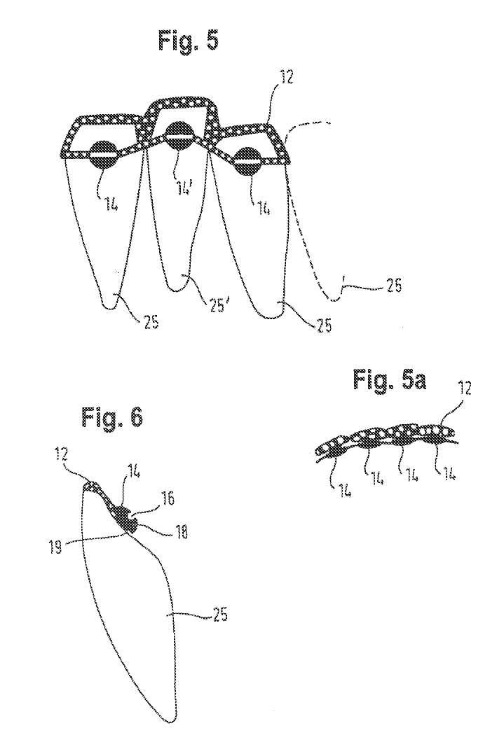

The fourth virtual planning step will now be described with reference to FIG. 5 which in particular is understandable by looking at it together with FIG. 3. In this drawing, the brackets 14, 14′, which are in turn attached to the teeth 25, 25′, are shown together with the positioning aid 12 attached thereto. In this case, this Figure shows the modeled arrangement of the brackets 14, 14′ together with the positioning aid 12 attached thereto in a state which corresponds to the uncorrected state of the teeth 25, 25′. This arrangement is calculated by a transformation of the teeth 25, 25′ from the target state to the actual state and the accompanying transformation of the brackets 14, 14′ joined thereto to this actual state. In other words, in the computer model the brackets 14, 14′ are appropriately attached to the teeth 25, 25′, the teeth 25, 25′ are then rotated and moved in such a way that they are translated to the actual state (which includes the malocclusion to be corrected), and the brackets 14, 14′ are moved and rotated together with the teeth 25, 25′. In this state, a positioning aid 12 is then determined which can hold the brackets 14, 14′ in this position determined in this way.

This positioning aid 12 which holds the brackets 14 is formed in one piece with said brackets 14. The positioning aid 12 is planned such that it attaches the brackets 14 at the position relative to the tooth at which they are to be attached such that by means of the positioning aid the teeth 25 are translatable into the configuration shown in FIG. 3 (as was described in other words above). Thus, for example, in the illustration shown in FIG. 5, the tooth 25′ would have to be moved downwards with respect to the teeth 25 located to the right and left of it so that it maintains the configuration shown in FIG. 3. So that the bracket 14 to be attached to said tooth maintains the right position relative to this tooth 25′, it must be positioned “further up” in the positioning tray 10 than the adjacent brackets 14 which is why the positioning tray 10 is offset in the middle, as is shown in FIG. 5. For easier understanding and to be able to differentiate the positioning aid 12 more easily from the brackets 14/14′, the positioning aid 12 is shown in a black and white pattern while the brackets 14/14′ are shown in solid black.

FIG. 5a shows a detailed view, namely a plan view onto the configuration shown in FIG. 5. The positioning aids 12 which are joined to the brackets 14 are shown here. The bracket foot 19 and the bracket body 18 can be seen.

FIG. 6 illustrates a longitudinal sectional view of a single tooth, which is shown in FIG. 5. A positioning aid 12 which extends over the incisal edge of the tooth 25 is also illustrated here as black with white dots. A bracket 14 with a bracket incision 16 is joined to the tooth 25 via the bracket foot 19 which joins the bracket base 18 directly to the tooth 25. Here, a “protrusion” between the bracket base 18 and the bracket foot 19 is used to accommodate rubber ligatures for immobilizing the ideal arch wire. It is preferable here for the material of the positioning aid to be selected from a less expensive material than the bracket material. As a result, costs can be reduced. In general, the materials of the positioning aid 12 and the brackets 14/14′ may differ, it being possible, for example, to make the brackets 14/14′ of a material that is more durable in the oral cavity than the positioning aid 12. This results in a cost saving as a more durable material such as this is generally more expensive and more difficult to machine than a corresponding less durable material.

1. Method for producing a positioning tray (10) for brackets of dental braces, wherein the positioning tray has a positioning aid (12) and one or more associated brackets (14), wherein the positioning aid (12) is formed in one piece with the associated brackets (14), comprising the following steps:
Obtaining source data which describe the present geometry of one or more teeth of at least one jaw of a patient,
Obtaining target data which describe the geometry of the one or more teeth of the at least one jaw of the patient after treatment with dental braces;
Calculating tray configuration data which describe the geometry of brackets (14) with respect to the present geometry of the one or more teeth of the at least one jaw of the patient and the positioning aid (12), arising from the source data and the target data,
wherein the calculation of the tray configuration data is carried out such that, using the described brackets (14) of this type, the positioning aid (12) is connected such that it can be used to position the brackets (14) with respect to the teeth of the patient, in such a way that the brackets (14) can be bonded to the surface of the teeth of the patient, and that, together with an arch wire to be connected to the brackets, a malocclusion can be corrected,
Producing, on the basis of the tray configuration data, a corresponding positioning tray (10) by means of a generative manufacturing process, preferably a 3D printing process, or an ablative manufacturing process.

2. Method according to claim 1, wherein the method is designed such that a point with reduced breaking strength (20), which serves as a predetermined breaking point, is formed in the positioning tray (10) at the transition between the brackets and the associated positioning aid to make it easier to separate the brackets (14) from said positioning aid (12).

3. Method according to one of the preceding claims, in which for producing the positioning trays (10), at least for that portion which forms the brackets (14), a generative manufacturing process is used which uses a composite that is mixed with ceramic particles and that preferably contains admixtures which meet the demands for strength and oral compatibility of the bracket (14).

4. Method according to one of claims 1-2, in which for producing the positioning trays (10), the positioning trays are manufactured from a ceramic or composite blank by means of an ablative process.

5. Apparatus for the production of a positioning tray (10) for brackets of dental braces, wherein the positioning tray (10) has a positioning aid (12) and one or more associated brackets (14), wherein the positioning aid (12) is formed in one piece with the associated brackets (14), with:
a device for obtaining source data which describe the present geometry of one or more teeth of at least one jaw of a patient, in particular a device which is equipped to capture an oral cavity of a patient,
a device for obtaining target data which describe the geometry to be achieved for the one or more teeth of the at least one jaw of the patient after treatment with dental braces, and which permit positioning of the brackets according to the curve of an ideal arch wire which is available and previously determined by the device,
a device for calculating tray configuration data which describe the geometry of brackets (14) with respect to the present geometry of the one or more teeth of the at least one jaw of the patient and the positioning aid, arising from the source data and the target data,
wherein the calculation of the tray configuration data is carried out such that, using the described brackets (14) of this type, the positioning aid (12) is connected such that it can be used to position the brackets (14) with respect to the teeth of the patient in such a way that the brackets (14) can be bonded to the surface of the teeth of the patient, and that, together with an ideal arch wire previously selected on the target model with the aid of the device and to be connected to the brackets (14), a malocclusion can be corrected, and
a device for producing, on the basis of the tray configuration data, a corresponding positioning tray by means of a generative manufacturing process, preferably a 3D printing process, or an ablative manufacturing process.

6. Apparatus according to claim 5, which is designed such that a point with reduced breaking strength (20), in particular a point with a weakened material thickness, which serves as a predetermined breaking point, is formed in the positioning tray (10) at the transition between the brackets (14) and the associated positioning aid (12) to make it easier to separate the brackets (14) from said positioning aid (12).

7. Apparatus according to claim 5 or 6, which is designed, for producing the positioning trays (10), at least for that portion which forms the brackets (14), to use a generative manufacturing process which uses a composite that is mixed with ceramic particles and that preferably contains admixtures which meet the demands for strength and oral compatibility of the bracket (14).

8. Apparatus according to one of claims 5-6, in which the device for producing, on the basis of the tray configuration data, a corresponding positioning tray is a device which can perform an ablative manufacturing process.

9. Machine-readable storage medium which contains a computer program that can control a method according to one of claims 1-4.

10. Positioning tray (10) for brackets of dental braces, wherein the positioning tray (10) has a positioning aid (12) and one or more associated brackets (14), wherein the positioning aid (12) is formed in one piece with the associated brackets (14).

11. Positioning tray according to claim 10, in which a point with reduced breaking strength (20), which serves as a predetermined breaking point, is formed at the transition between the brackets (14) and the associated positioning aid (12) to make it easier to separate the brackets from said positioning aid.
